(19) United States
(12) Patent Application Publication
(10) Pub. No.: US 2021/0365506 A1
(43) Pub. Date: Nov. 25, 2021

(54) AUTOMATIC CONVERSION OF WEBPAGE DESIGNS TO DATA STRUCTURES

(71) Applicant: Microsoft Technology Licensing, LLC, Redmond, WA (US)

(72) Inventors: Jane May Chu, Bellevue, WA (US); Jason W. Falk, Seattle, WA (US); Phoi Heng Lew, Mill Creek, WA (US)

(21) Appl. No.: 16/882,389

(22) Filed: May 22, 2020

(51) Int. Cl. G06F 16/958; G06N 20/00; G06F 8/38; G06F 16/957

(52) U.S. Cl. CPC G06F 16/958; G06F 16/957; G06F 8/38; G06N 20/00

(57) ABSTRACT

Techniques for developing webpages for rendering and displaying in a web browser are disclosed herein. One example technique includes upon receiving an image of the webpage design, retrieving a recognition model that correlates visual features of images to UI components of multiple component types and one or more properties of the UI components and recognizing the UI component in the received image of the webpage design, a property of the UI component, and a value of the property of the UI component, based on the recognition model. The recognized UI component can then be automatically converted into a data structure containing the component type of the UI component, the property of the UI component, and the value of the property of the UI component, the data structure being useful for generating codes of a webpage corresponding to the webpage design.

### BACKGROUND

Websites typically include a collection of webpages published on web servers for access via the Internet. A webpage is a document composed according to a web design language for rendering and displaying in a web browser. Examples of web design language include Hypertext Markup Language (“HTML”) and Extensible Markup Language (“XML”). Various components of a webpage can identify content as well as identify manners according to which text, images, videos, or other types of content is rendered and displayed on the webpage. A webpage can also be linked to other webpages via hyperlinks. When a user clicks on a hyperlink on a webpage, a web browser can retrieve a new webpage defined in the hyperlink to render and display the new webpage in place of the original webpage in the web browser.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Developing a website typically starts with a design team generating a design of various webpages of the website. The design can include arrangements of various user interface (“UI”) components for rendering and displaying text, image, video, or other types of content on a webpage as well as desired functionalities of such UI components. For example, a design of a webpage can include a title component having a text property for containing a string value for use as a caption for the title component. In another example, a design can also include a button component with a text property for containing a label for the button component as well as an appearance property that defines a visual appearance of the button component (e.g., primary, secondary, etc.). In further examples, the design of a webpage can also include image, link action, paragraph, video, or other suitable types of UI components with corresponding properties.

Upon completion of the design, the design team can pass the design of the webpage to a prototype team for functionalizing the various UI components on the design using, for instance, a pseudocode. For example, the prototype team can generate data structures that describe suitable rendering and displaying of the UI components as well as functionalizing the UI components on the webpage. Upon completion of prototyping the webpage according to the design, the prototype team can send the prototyped webpage back to the design team for verification. Upon receiving feedback from the design team, prototype team can revise and reconfigure the prototyped webpage and send the revised webpage to the design team for further feedback. Such a feedback and revision process can be repeated multiple times until the prototyped webpage is satisfactory to the design team. Subsequently, a production team can convert the prototyped webpage to HTML, XML, or other suitable types of web design codes for deployment on webservers.

The foregoing process for developing a website or webpage can have certain drawbacks. First, the foregoing process can be error prone because communications between the design team and the prototype team can sometimes be distorted such that the intent of the webpage design is misunderstood, misinterpreted, or misconstrued during prototyping. Messages, or meanings of the messages, from one team or team member to another can often mutate when the messages are transmitted, repeated, paraphrased, or responded to multiple times. Secondly, the foregoing process involves having the design team providing feedback to the prototype team multiple times for adjusting the prototyped webpage. Such repetitive operations in order to converge on a satisfactory design can be labor intensive and costly.

Several embodiments of the disclosed technology can address certain aspects of the foregoing drawbacks by implementing at least partially automated prototyping of designs of webpages. In some implementations, a design team (or other suitable entities) can generate a data schema for defining various UI components of designs for webpages. For example, a design team can define a data schema for a button component to include definitions of appearance, text, state, or other types of properties of the button component and possible values of such properties. The appearance property can include a property value that describes a color, shading, or other visual features of a button component as a primary or secondary appearance. The text property can include a text value (e.g., a text string) that is a label for the button component. The data schema can also include a state property that can include a value of enabled or disabled or other suitable types of properties for a button component. In other embodiments, the data schema can also be generated automatically using existing webpages or via other suitable techniques.

In certain embodiments, the data schema can also include a child property that can be configured to define one or more levels of nested child or sub-components in a UI component. For example, one child property can include a button component subordinate to a login component while another child property can include a heading component subordinate to an image component. The sub-components can also further include additional subordinate components of their own with additional levels of nesting. As described in more detail later, such nested child properties can be used to identify multiple levels of sub-components of a webpage design to facilitate automated generation of data structures that describe the webpage design.

Using the data schema, a data generator can be configured to generate one or more sets of component data of UI components according to the defined data schema. For instance, in the example above, the data generator can be configured to generate component data for multiple button components that have different appearances and/or labels of text values according to the defined data schema. Each set of component data can include an appearance value and a text value corresponding to the appearance and text properties, respectively. Using both the data schema and the component data, a data visualizer can be configured to create a screenshot or other suitable types of image of the button components with respective appearances and text values as labels. For instance, the data visualizer can generate an image of a button (e.g., a rectangular square) having an appearance defined by the appearance value (e.g., primary) and a label defined by the text value generated by the data generator (e.g., “Hello World!”).

A model developer can be configured to develop a recognition model of the various UI components defined in the data schema using both the component data and the screenshots generated using the component data as training datasets. In certain implementations, the model developer can be configured to identify the various UI components on the screenshots based on the training datasets using a “neural network” or “artificial neural network” configured to “learn” or progressively improve performance of tasks by studying known examples. The neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the model developer can provide a recognition model 118 that can be used by a prototype developer to automatically convert a design for a webpage into a data structure suitable for generating HTML, XML, or other web design codes for the webpage. In additional implementations, the model developer can be configured to generate the recognition model based on user provided rules or via other suitable techniques.

In operation, a prototype developer can be configured to use the recognition model from the model developer to automatically generate a data structure that describes a design for a webpage via computer vision. For instance, the design team can generate a screenshot or image that includes multiple UI components for a design of a webpage. Upon receiving the screenshot or image, for example, via a camera or scanner, the prototype developer can be configured to determine whether an area of the screenshot or image contains nested UI components based on the recognition model. For instance, the recognition model of a card component can indicate one or more possible subcomponents such as a title, image, or paragraph subcomponent. Based on the indication, the prototype developer can be configured to search the focused area and determine whether a title or image is found. Upon finding a title or image, the prototype developer can indicate that the area includes nested UI components. Otherwise, the prototype developer can indicate that the area contains no nested UI components.

In response to determining that the area does not contain any nested UI components, the prototype developer can be configured to identify and recognize the UI component on the screenshot or image based on visual appearances of the UI component using the recognition model. For example, the prototype developer can identify that a UI component having a rectangular shape and a label of text within the rectangular shape corresponds to a button component. The prototype developer can then be configured to identify various properties of the button component. For example, the prototype developer can identify an appearance of the button component based on a color, shading, or other suitable parameters of the rectangular shape. The prototype developer can also identify a text property by identifying the label of text via Optical Character Recognition (“OCR”). Upon completion of identifying the button component and associated properties, the prototype developer can be configured to convert the identified UI component into a data structure having various properties and property values that describe the UI component. As such, the prototype developer can identify the UI component as a button component and using a data structure with an appearance and text properties to describe the appearance and label of the recognized button component.

In response to determining that the area does contain nested UI components, the prototype developer can be configured to identify the next largest sub-area in the focused area and determine whether the sub-area contains nested UI components. Upon determining that the sub-area does not contain nested UI components, the prototype developer can be configured to recognize the UI component and convert the recognized UI component into another data structure, as described above. Upon determining that the sub-area does contain nested UI components, the prototype developer can be configured to repeat the foregoing processes until no more nested UI components is found. As such, by implementing the foregoing recognition and conversion procedures, the prototype developer can be configured to convert the screenshot or image of the design for the webpage into a data structure in, for instance, pseudocode that describes the various U components on the webpage. A production team can then develop and deploy HTML, XML, or other suitable web design codes for the webpage based on the data structure from the prototype developer.

Several embodiments of the disclosed technology can at least reduce risks of miscommunication between the design team and the prototype team. By using the prototype developer, a design for a webpage from the design team can be automatically converted into a data structure in, for instance, pseudocode. As such, communications between the design team and the prototype team can be at least reduced or even eliminated. The foregoing technique can also reduce time and efforts for developing the webpage by at least reducing the feedback and adjustment operations between the design and prototype teams. As such, costs for developing webpages and websites can be reduced when compared to using the feedback and adjustment process.

### BRIEF DESCRIPTION OF THE DRAWINGS

FIGS. 1A and 1B are schematic diagrams illustrating a computing system implementing a model developer for developing a recognition model for automatic conversion of webpage designs to data structures in accordance with embodiments of the disclosed technology.

FIG. 2 is a schematic diagram illustrating a computing system implementing automatic conversion of webpage designs to data structures in accordance with embodiments of the disclosed technology.

FIGS. 3A and 3B are flowcharts illustrating processes of automatic conversion of webpage designs to data structures during prototyping in accordance with embodiments of the disclosed technology.

FIG. 4 is a computing device suitable for certain components of the computing system in FIGS. 1A-2.

### DETAILED DESCRIPTION

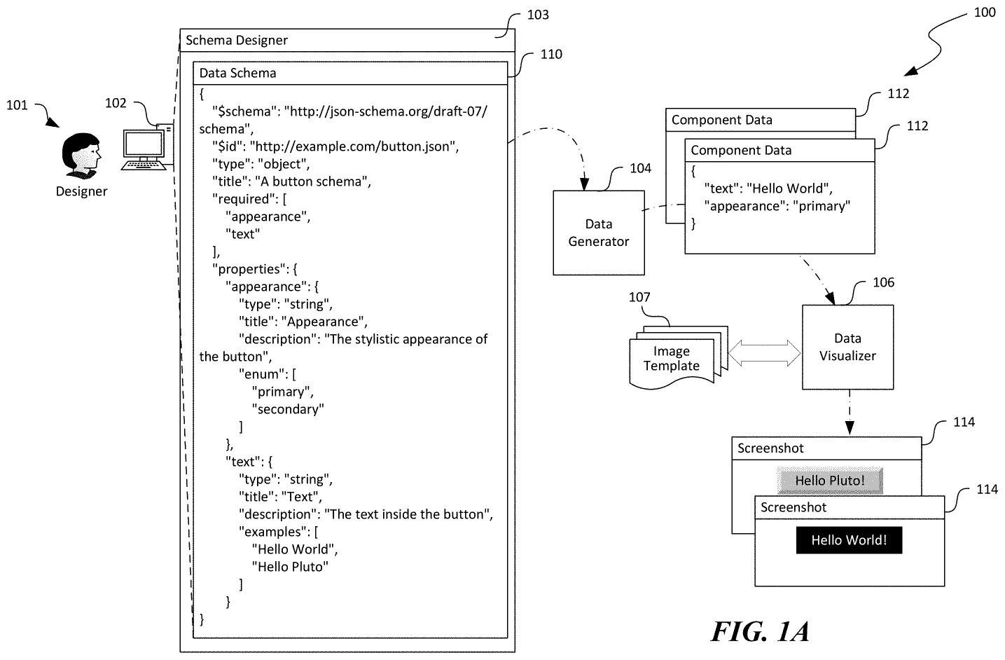

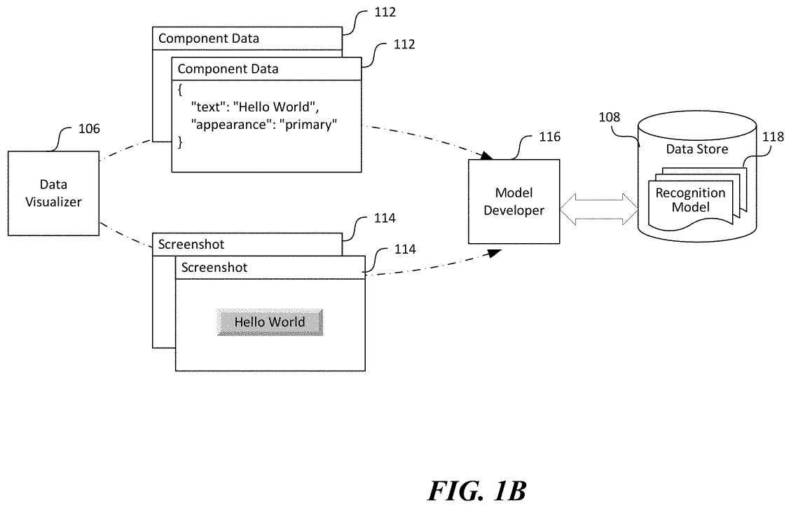

Certain embodiments of systems, devices, components, modules, routines, data structures, and processes for automatic conversion of webpage designs to data structures are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-4.

As used herein, a UI component can be a user interface element designed for rendering and displaying corresponding types of content on a webpage. For example, a UI component can include a button component designed to render and display a toggle button on a webpage. In another example, a UI component can include a table component designed to render and display an array of data on a webpage. In yet another example, a UI component can also include a user interface element designed to render and display a dialog, video, image, paragraph, or other suitable types of content.

Also used herein, a data schema can be a diagrammatic representation of a data structure that can be used to describe a UI component. A data schema can identify various properties of a data structure that describes a UI component as well as possible values of the properties. A data structure is a manifestation of a corresponding data schema used in a data resource. For instance, the following can be an example data schema for a button component:

{

“$schema”: “http://json-schema.org/draft-07/schema”,
“$id”: “http://example.com/button.json”,
“type”: “object”,
“title”: “A button schema”,
“required”: [

“appearance”,
“text”

],
“properties”: {

“appearance”: {

“type”: “string”,
“title”: “Appearance”,
“description”: “The stylistic appearance of the button”,
“enum”: [

“primary”,
“secondary”

]

},
“text”: {

“type”: “string”,
“title”: “Text”,
“description”: “The text inside the button”,
“examples”: [

“Hello World”,
“Hello Pluto”

]

}

}

}

As shown above, the example data schema can include a source (i.e., “http://json-schema.org/draft-07/schema”), an identifier (i.e., http://example.com/button.json), a type (i.e., “object”), a title (i.e., “A button schema”), and identification of one or more required properties (i.e., “appearance” and “text”). The data schema can also define each of the properties, such as “appearance,” with corresponding type, title, description, and possible values, i.e., “primary” and “secondary.” Using the foregoing data schema, component data can be generated for a button component having a syntax according to the defined data schema. For instance, the following is an example of component data for a button component with corresponding appearances and text property values:

{

“text”: “Hello World!”,
“appearance”: “primary”

}.

A data schema can be defined by a designer, a design team, and/or at least partially generated automatically based on, for instance, existing webpages or via other suitable techniques.

Typical webpage development involves multiple rounds of feedback and adjustment of a prototyped design for a webpage between a design team and a prototype team. Such a development process can be error prone and costly. Several embodiments of the disclosed technology can address certain aspects of the foregoing drawbacks by implementing at least partially automated prototyping of designs of webpages. By using a prototype developer, a design for a webpage from the design team can be automatically converted into a data structure using a recognition model. As such, communications between the design team and the prototype team can be at least reduced or even eliminated. The disclosed technique can also reduce time and efforts for developing the webpage by at least reducing the feedback and adjustment operations between the design and prototype teams. As such, costs for developing webpages and websites can be reduced when compared to using the feedback and adjustment process, as described in more detail below with reference to FIGS. 1A-4.

FIGS. 1A and 1B are schematic diagrams illustrating a computing system 100 implementing a model developer for developing a recognition model for automatic conversion of webpage designs to data structures in accordance with embodiments of the disclosed technology. In FIG. 1A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

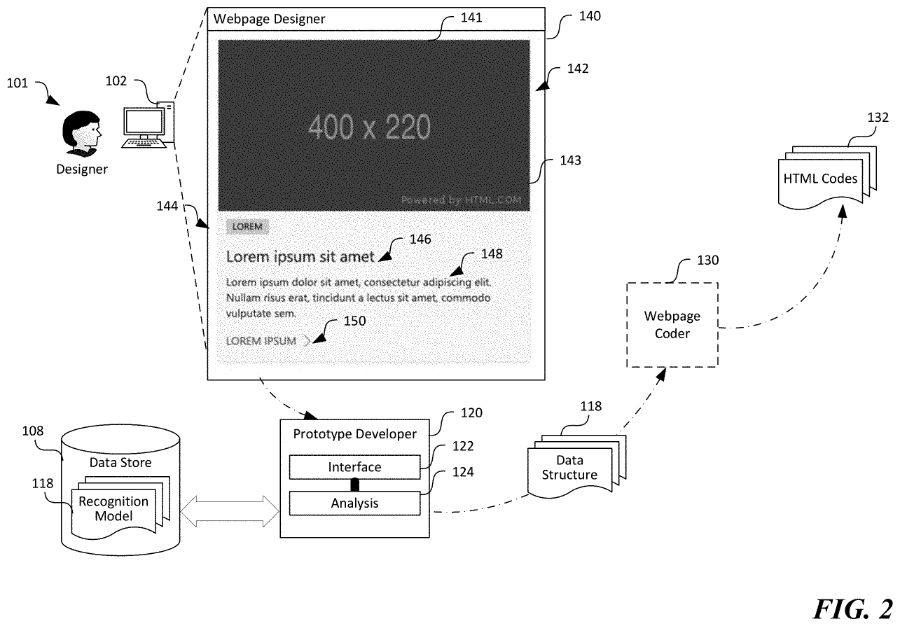

As shown in FIG. 1A, the computing system 100 can include a schema designer 102 hosted on a computing device 102, a data generator 104, and a data visualizer 106 operatively coupled to one another via, for instance, a computer network (not shown). Though the schema designer 103, the data generator 104, and the data visualizer 106 of the computing system 100 are shown as being separate from one another, in certain implementations, at least some of the foregoing components may be integrated into a single computing device. For example, at least one of the data generator 104 or the data visualizer 106 may be integrated onto the computing device 102 with the schema designer 103. In further examples, the computing device 102 can also be configured to integrate the model developer 116 (shown in FIG. 1B), the prototype developer 120 (shown in FIG. 2), or other suitable components of the computing system 100.

The computing device 102 can be configured to facilitate a designer 101 to perform various tasks. For example, the computing device 102 can facilitate the user 101 to compose, modify, or perform other suitable actions on a data schema 110. In other examples, the computing device 102 can also facilitate the user 101 to perform various computational, communication, or other suitable types of tasks. In the illustrated embodiment, the computing device 102 includes a desktop computer. In other embodiments, the computing device 102 can also include a laptop computer, a tablet, a smartphone, or other suitable types of electronic device with additional and/or different hardware/software components.

The schema designer 103 can be configured to facilitate composition or modification of a data schema 110 by the designer 101. In one implementation, the schema designer 103 can include a text editor. In other implementations, the schema designer 103 can include another suitable type of application for receiving input from the designer 101 and generate a data schema 110 according to the received input. Though not shown in FIG. 1A, the schema designer 103 can include various menu items such as creating a new data schema 110, open and/or save an existing data schema 110, or other suitable menu items. In the illustrated example, the data schema 110 corresponds to a button component with example properties of “appearance” and “text.” In other examples, the data schema 110 can correspond to other suitable types of UI components and/or include additional or different properties.

As shown in FIG. 1A, upon creating, editing, or otherwise generating the data schema 110, the designer 101 can transmit the data schema 110 to the data generator 104 for generating a set of example component data 112 according to the data schema 110. In one embodiment, the data generator 104 can be configured to analyze the various defined properties of the UI component in the data schema 110 and generate component data 112 that complies with the various definitions and possible values of the properties. In other embodiments, the data generator 104 can be configured to generate the component data 112 in other suitable fashions. As such, the data generator 104 can generate a set of component data 112 based on the data schema 110. For instance, as shown in FIG. 1A, example component data 112 for a button component generated based on the example data schema 110 can be as follows:

{

“text”: “Hello World!”,
“appearance”: “primary”

}.

As shown above, the example button component can be a button that has a “primary” appearance and a displayed label of “Hello World!” The data generator 104 can also generate additional and different component data 112 based on the same data schema 110. For instance, the following is another example component data 112 for another button component:

{

“text”: “Hello Pluto!”,
“appearance”: “secondary”

}.

Thus, the example button component above has a different appearance and label, i.e., “Hello Pluto!” and “secondary” than those of the other example button component above.

Upon generating the set of component data 112, the data generator 104 can transmit the component data 112 to the data visualizer 106 for generating screenshots 114 (or other suitable types of images) of UI components based on the component data 112. In certain embodiments, the data visualizer 106 can be configured to identify an image template 107 (e.g., “button”) based on an identifier of the UI component in the component data 112. The data visualizer 106 can then format a copy of the image template 107 using property values of the various properties defined in the component data 112 to generate the screenshot 114. For example, as shown in FIG. 1A, the data visualizer 106 can retrieve an image template 107 corresponding to a button (i.e., a button with beveled edges shown in FIG. 1A). The data visualizer 106 can then be configured to format the image template 107 to have a first appearance of “primary,” e.g., with a dark background and light foreground or a second appearance of “secondary,” e.g., with a light background and dark foreground. The data visualizer 106 can also format a label of the buttons based on the text values of the text properties, i.e., “Hello World!” and “Hello Pluto!” Though not shown in FIG. 1A, in other examples, the data visualizer 106 can be configured to generate screenshots with nested UI components, such as that shown in FIG. 2.

Upon generating the screenshots 114 based on the component data 112, the data visualizer 106 can be configured to transmit both the screenshots 114 and the component data 112 to the model developer 116 for generating a recognition model 118 that correlates visual features of the screenshots 114 to one or more of the UI components based on (i) the generated component data 112 and (ii) the set of screenshots 114 generated based on the component data 112. In certain implementations, the model developer 116 can be configured to identify the various UI components on the screenshots based on the training datasets using a “neural network” or “artificial neural network” configured to “learn” or progressively improve performance of tasks by studying known examples. The neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection.

Typically, artificial neurons are organized in layers. Different layers may perform different kinds of transformations on respective inputs. Signals typically travel from an input layer, to an output layer, possibly after traversing one or more intermediate layers. Thus, by using a neural network, the model developer 116 can provide a recognition model 118 that can be used by the prototype developer 120 (shown in FIG. 2) to automatically convert a design for a webpage into a data structure suitable for generating HTML, XML, or other web design codes for the webpage, as described in more detail below with reference to FIG. 2. In other implementations, the model developer 116 can be configured to generate the recognition model 118 based on user provided rules or via other suitable techniques. In the illustrated example in FIG. 1B, the recognition model 118 is stored in a data store 108 operative coupled to the model developer 116. In other examples, the recognition model 118 can be stored in other suitable locations and/or made accessible to the prototype developer 120 in other suitable manners.

FIG. 2 is a schematic diagram illustrating a computing system 100 implementing automatic conversion of webpage designs to data structures in accordance with embodiments of the disclosed technology. As shown in FIG. 2, the computing system 100 can include a computing device 102 configured to execute suitable instructions with a processor to provide a webpage designer 140 and a prototype developer 120 operatively coupled to one another. Though the webpage designer 140 and the prototype developer 120 are shown as separate in FIG. 2, in certain implementations, both of these components may be integrated in the computing device 102 or another suitable computing device (e.g., a server, not shown). In further implementations, one or more of the foregoing components can also be integrated with those shown in FIGS. 1A and 1B.

The web page designer 140 can be configured to provide facilities, such as template galleries of UI components and menus, the designer 101 can use to compose a design 141 for a webpage. One suitable webpage designer 140 is Adobe Photoshop provided by Adobe of San Jose, Calif. As shown in FIG. 2, the example design 141 can include a card 142 that includes child components of an image 143, a badge 144, a heading 146, a paragraph 148, and a linked action 150. In other examples, the design 141 can include additional and/or different UI components with or without child components.

As shown in FIG. 2, the prototype developer 120 can include an interface module 122, an analysis module 124, and a conversion module 126 operatively coupled to one another. Though only the foregoing modules are shown in FIG. 2, in other embodiments, the prototype developer 120 can also include network, database, or other suitable types of modules.

The interface module 122 can be configured to capture an image of the design 141. For example, in one embodiment, the interface module 122 can include a camera driver that is configured to capture a snapshot of the design 141 on a whiteboard, piece of paper, or other media via a camera or scanner (not shown). In other embodiments, the interface module 122 can be configured to capture the snapshot of the design 141 by receiving the design 141 as an image or other suitable types of electronic file. In further embodiments, the interface module 122 can be configured to manually target one or more websites and capture screenshots of such websites instead of receiving the design 141 from the webpage designer 140. The captured screenshots can then be processed by the analysis module 124 as described below and compiled into a library of webpage designs or for other suitable uses. Upon receiving the design 141, the interface module 122 can be configured to pass the design 141 to the analysis module 124 for further processing.

The analysis module 124 can be configured to analyze one or more areas on the received design 141 and recognize UI components and sub-components on the design 141 based on the recognition model 118 from the data store 108. For example, the analysis module 124 can be configured to determine whether an area of the screenshot or image of the design 141 contains nested UI components. For instance, as shown in FIG. 2, the analysis module 124 can first recognize that the design 141 includes a card component 143. The analysis module 124 can then determine, based on the recognition model 118, that the card component 142 can have one or more possible subcomponents such as a title, image, or paragraph component. Based on the indication, the analysis module 124 can be configured to search the focused area and determine whether any of such sub-components can be found. Upon finding one of the foregoing UI components, e.g., the image 143, the analysis module 124 can be configured to indicate that the area includes nested UI components. Otherwise, the analysis module 124 can indicate that the area contains no nested UI components.

In response to determining that the area does not contain any nested UI components, the analysis module 124 can be configured to identify and recognize the UI component on the screenshot or image based on visual appearances of the UI component using the recognition model 118. For example, the analysis module 124 can identify that an area corresponding the image component 143 based on visual features included in the area containing the image component 143. The analysis module 124 can then be configured to identify various properties of the image component. In the illustrated example, the analysis module 124 can identify that a source property of the image component 143 includes a string, i.e., “https://placehold.it/400x220/414141” that is a source of the image in the image component 143. In another example, the analysis module 124 can also identify that the paragraph component 148 can include a size property, e.g., a number of words, and a text property containing text processed via Optical Character Recognition (“OCR”). In further examples, the analysis module 124 can also generate multiple candidate UI components based on the recognition model 118. For instance, the analysis module 124 can identify that an area corresponding the image component 143 can be an image component or another badge component. In certain implementations, the analysis module 124 can be configured to output all candidate UI components to the designer 101 for selection. In other implementations, the analysis module 124 can be configured to select a closest match (e.g., the image component) based on the visual features and optionally output the other candidates (e.g., the badge component) as one or more alternates.

In response to determining that the area does contain nested UI components, the analysis module 124 can be configured to identify the next largest sub-area in the focused area and determine whether the sub-area contains nested UI components. For example, upon identifying the card component 142 includes an image component 143, a badge component 144, a heading component 146, a paragraph component 148, and a linked-action component 150, the analysis module 124 can be configured to determine whether the image component 143 includes additional sub-components. Upon determining that the sub-area, e.g., the image component 143, does not contain nested UI components, the analysis module 124 can be configured to recognize the UI component and convert the recognized UI component into a data structure. In one embodiment, the data structure can be generated according to the data schema 110 of FIG. 1A. In other embodiments, the data structure can be generated according to other suitable data schemas.

Upon determining that the sub-area also contains nested UI components, the analysis module 124 can be configured to repeat the foregoing processes until no more nested UI components is found. As such, by implementing the foregoing recognition and conversion procedures, the analysis module 126 can be configured to convert the screenshot or image of the design 141 for the webpage into a data structure in, for instance, pseudocode that describes the various UI components on the webpage. The following is an example data structure converted based on the screenshot of the design 141 in FIG. 2:

{

“card-root”: {

“data”: {

“children”: [

{

“id”: “image-1”

},
{

“id”: “badge-1”

},
{

“id”: “heading-1”

},
{

“id”: “paragraph-1”

},
{

“id”: “linked-action-1”

}

]

}

},
“image-1”: {

“data”: {

“src”: “https://placehold.it/400x220/414141”

}

},
“badge-1”: {

“data”: {

“text”: “LOREM”

}

},
“heading-1”: {

“data”: {

“size”: 4,
“text”: “Lorem ipsum sit amet”

}

},
“paragraph-1”: {

“data”: {

“size”: 2,
“text”: “Lorem ipsum dolor sit amet, consectetur

adipiscing elit. Nullam risus erat, tincidunt a lectus sit amet, commodo
vulputate sem.”

}

},
“linked-action-1”: {

“data”: {

“text”: “LOREM IPSUM”

}

}

},
“card-root”

As shown above, the prototype developer 120 can be configured to identify that the design 141 includes a card component 142 that has several sub-components, i.e., the image component 142, the badge component 144, the heading component 146, the paragraph component 148, and the linked-action component 150 identified individually with a component ID, e.g., “image-1.” The data structure above can also define and describe various properties of the component and sub-components. For instance, the badge component 144 can include a text property with a value of “LOREM.” As such, based on the data structure, an optional webpage coder 130 or a production team can then develop and deploy HTML, XML, or other suitable web design codes for the webpage based on the data structure from the prototype developer 120.

Several embodiments of the disclosed technology can thus at least reduce risks of miscommunication between the design team and the prototype team. By using the prototype developer 120, a design 141 for a webpage from the designer 101 can be automatically converted into a data structure in, for instance, pseudocode. As such, communications between the designer 101 and the prototype team can be at least reduced or even eliminated. The foregoing technique can also reduce time and efforts for developing the webpage by at least reducing the feedback and adjustment operations between the design and prototype teams. As such, costs for developing webpages and websites can be reduced when compared to using the feedback and adjustment process.

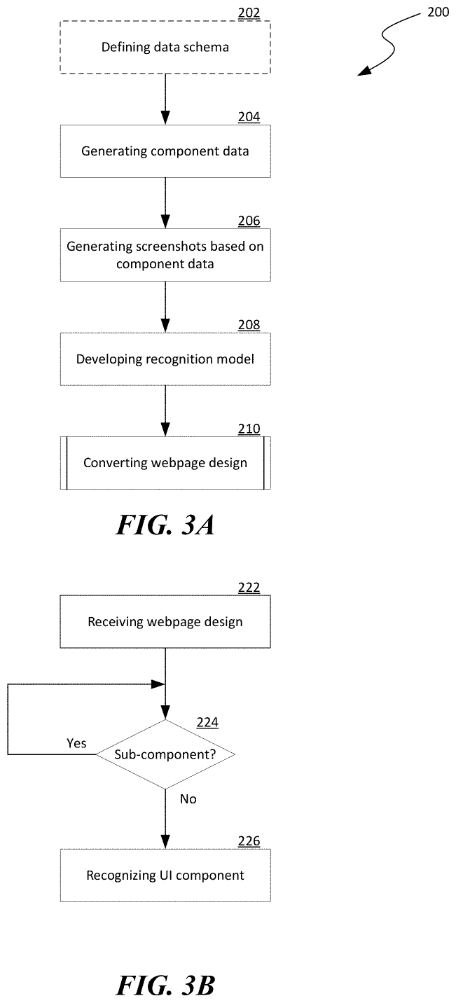

FIGS. 3A and 3B are flowcharts illustrating processes of automatic conversion of webpage designs to data structures during prototyping in accordance with embodiments of the disclosed technology. Though various aspects of the processes are described below in the context of the computing system 100 described above with reference to FIGS. 1A-2, embodiments of the processes can also be implemented in computing systems with additional and/or different components. As shown in FIG. 3A, a process 200 can optionally include defining a data schema for UI components of a webpage at stage 202. The data schema can include an identifier of a UI component, one or more properties of the UI component, as well as possible values of the one or more properties. An example data schema is described above with reference to FIG. 1A.

The process 200 can also include generating component data of UI components based on the defined data schema at stage 204. The component data can be generated to comply with a syntax of the defined data schema. As such, the component data can include at least an identifier of the UI component as well as one or more properties and associated property values as defined in the data schema. The process 200 can further includes generating screenshots or other suitable types of images of the UI components using the generated component data at stage 206. The screenshots can be generated using image templates and formatting such image templates according to the property values of the one or more properties of the UI component, as described above with reference to FIG. 1B.

The process 200 can further includes developing a recognition model for recognizing various screenshots of UI components at stage 208. In certain implementations, a neural network can be used to develop the recognition model based on both the component data and the corresponding screenshots generated based on the component data. In other implementations, the recognition model can be generated in other suitable manners, as described above with reference to FIG. 1B. The process 200 can then include converting a screenshot or other suitable types of image of a design for a webpage into a data structure at stage 210. Example operations of such conversion are described below with reference to FIG. 3B. Though the process 200 shown in FIG. 3A includes stage 210 for converting a screenshot or other suitable types of image of a design for a webpage into a data structure, in other embodiments, stage 210 can be omitted from the process 200 and instead performed independently from other operations of the process 200.

As shown in FIG. 3B, example operations for converting a screenshot of a design into a data structure can include receiving a design for a webpage at stage 222. The operations can then include a decision stage 224 to determine whether the received design includes any sub-component. In response to determining that the design does not include any sub-component, the operations proceed to recognizing the UI component at stage 226, as described above with reference to FIG. 2. In response to determining that the design does include sub-components, the operations revert back to determining whether a sub-component also includes additional sub-components at stage 224. The operations continue until no more sub-components are identified before proceeding to recognizing each of the sub-components at each level of nesting.

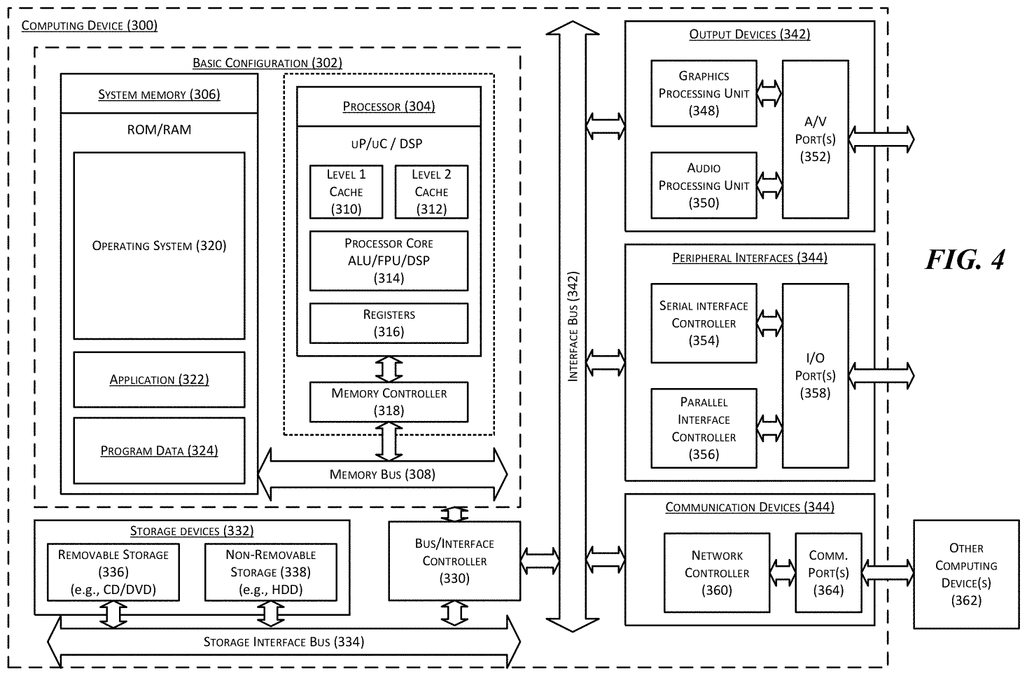

FIG. 4 is a computing device 300 suitable for certain components of the computing system 100 in FIGS. 1A-2. For example, the computing device 300 can be suitable for the computing device 102, the data generator 104, the data visualizer 106, the model developer 116, and the prototype developer 120 of FIGS. 1A-2. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 4 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

1. A method of developing webpages for rendering and displaying in a web browser on a computing device, the method comprising:
generating component data that describes user interface (UI) components of webpages according to a set of pre-defined data schemas corresponding to component types of the UI components, the component data identifying each of the UI components and one or more properties of the UI components and complying with a syntax of one of the pre-defined data schemas;
generating a set of screenshots of the UI components of the webpages based on the generated component data according to the set of pre-defined data schemas;
developing, via machine learning, a recognition model that correlates visual features of the generated set of screenshots to one or more of the UI components based on (i) the generated component data according to the set of pre-defined data schemas and (ii) the set of screenshots generated based on the generated component data; and
using the developed recognition model to automate prototyping of a webpage design, including, upon receiving an image of the webpage design,
recognizing one or more UI components in the received image by identifying visual features of the image that correlate to component data of one or more of the component types based on the developed recognition model; and
automatically converting the recognized one or more UI components into one or more data structures according to one or more of the pre-defined data schemas, the data structures for creating codes for a webpage corresponding to the webpage design.

2. The method of claim 1 wherein:
the set of data schemas individually defines the one or more properties of one of the UI components and possible values suitable for the one or more properties; and
generating the component data includes generating component data that has a set of values from the possible values individually corresponding to the one or more properties.

3. The method of claim 1 wherein:
the set of screenshots individually having one or more visual features corresponding to the one or more properties of the UI components in the component data; and
developing the recognition model includes developing the recognition model that correlates the one or more visual features of the screenshots to the one or more UI components.

4. The method of claim 1 wherein:
recognizing the one or more UI components in the received image includes:
identifying the one or more UI components based on the recognition model; and
identifying the one or more properties of the identified one or more UI components.

5. The method of claim 1 wherein:
recognizing the one or more UI components includes:
determining whether one of the one or more UI components includes a child UI component; and
in response to determining that the one of the one or more UI components includes a child UI component, determining whether the child UI component includes another child UI component of its own.

6. The method of claim 1 wherein:
recognizing the one or more UI components includes:
determining whether one of the one or more UI components includes a child UI component;
in response to determining that the one of the one or more UI components includes a child UI component, determining whether the child UI component includes another child UI component of its own; and
in response to determining that the child UI component does not include another child UI component, based on the recognition model,
identifying the child UI component and one or more properties thereof; and
identifying the one of the one or more UI components and one or more properties thereof.

7. The method of claim 1 wherein:
recognizing the one or more UI components includes:
determining whether one of the one or more UI components includes a child UI component; and
in response to determining that the one of the one or more UI components does not include a child UI component, based on the recognition model, identifying the one of the one or more UI components and the one or more properties thereof.

8. The method of claim 1 wherein:
one of the set of data schemas includes a property that defines a child UI component of one of the component types; and
generating the set of screenshots includes generating a screenshot of one of the one or more UI components of the one of the component types with the child UI component.

9. The method of claim 1 wherein:
the one or more data structures individually include a set of values and a component identifier; and
the method further includes automatically converting the one or more data structures into codes of a webpage displayable in a web browser.

10-20. (canceled)

21. A method of developing webpages for rendering and displaying in a web browser on a computing device, the method comprising:
receiving a pre-defined data schema corresponding to a user interface (UI) component type for a webpage;
generating training component data that describes multiple UI components of the UI component type according to the received data schema, the training component data identifying each of the multiple UI components and one or more properties of the multiple UI components and complying with a syntax of the received data schema;
based on the generated training component data, creating multiple training screenshots individually having visual features described by the generated training component data;
developing, via machine learning, a recognition model that correlates the visual features of the created multiple training screenshots to the multiple training UI components using both (i) the generated training component data according to the defined data schema and (ii) the multiple training screenshots created based on the generated training component data to; and
automating, based on the developed recognition model, prototyping of a webpage design, including, upon receiving an image of the webpage design,
recognizing, according to the developed recognition model, a UI component in the received image by identifying one or more visual features of the UI component in the image that correlate to at least some of the training component data of the component type; and
automatically converting the recognized UI component into a data structure having data complying with the received data schema.

22. The method of claim 21 wherein:
the data schema defines the one or more properties of the training UI components and possible values suitable for the one or more properties; and
generating the training component data includes generating the training component data that has a set of values from the possible values individually corresponding to the one or more properties.

23. The method of claim 21 wherein:
recognizing the UI component includes:
determining whether the UI component includes a child UI component; and
in response to determining that the UI component includes a child UI component, determining whether the child UI component includes another child UI component of its own.

24. The method of claim 21 wherein:
recognizing the UI component includes:
determining whether the UI component includes a child UI component;
in response to determining that the UI component includes a child UI component, determining whether the child UI component includes another child UI component of its own; and
in response to determining that the child UI component does not include another child UI component, based on the recognition model,
identifying the child UI component and one or more properties of the child UI component; and
identifying the UI component and one or more properties of the UI component.

25. The method of claim 21 wherein:
recognizing the UI component includes:
determining whether the UI component includes a child UI component; and
in response to determining that the UI component does not include a child UI component, based on the recognition model, identifying the one or more properties of the UI component.

26. The method of claim 21 wherein:
the data schema includes a property that defines a child UI component of the component type; and
creating the multiple training screenshots includes creating one of the multiple screenshots of the UI component of the component type with the child UI component.

27. The method of claim 21 wherein:
the data structure includes a set of values and a component identifier; and
the method further includes automatically converting the data structure into codes of a webpage displayable in a web browser.

28. A computing device, comprising:
a processor; and
a memory operatively coupled to the processor, the memory including instructions that when executed cause the processor to:
generate component data that describes user interface (UI) components of webpages according to a set of pre-defined data schemas corresponding to component types of the UI components, the component data identifying each of the UI components and one or more properties of the UI components and complying with a syntax of one of the pre-defined data schemas;
create a set of screenshots of the UI components of the webpages based on the generated component data according to the set of pre-defined data schemas;
develop, via machine learning, a recognition model that correlates visual features of the generated set of screenshots to one or more of the UI components based on (i) the generated component data according to the set of pre-defined data schemas and (ii) the set of screenshots generated based on the generated component data; and
use the developed recognition model to automate prototyping of a webpage design, including to, upon receiving an image of the webpage design,
recognize one or more UI components in the received image by identifying visual features of the image that correlate to component data of one or more of the component types based on the developed recognition model; and
automatically convert the recognized one or more UI components into one or more data structures according to one or more of the pre-defined data schemas, the data structures for creating codes for a webpage corresponding to the webpage design.

29. The computing device of claim 28 wherein:
to recognize the one or more UI components includes to:
determine whether one of the one or more UI components includes a child UI component; and
in response to determining that the one of the one or more UI components includes a child UI component, determine whether the child UI component includes another child UI component of its own.

30. The computing device of claim 28 wherein:
to recognize the one or more UI components includes to:
determine whether one of the one or more UI components includes a child UI component;
in response to determining that the one of the one or more UI components includes a child UI component, determine whether the child UI component includes another child UI component of its own; and
in response to determining that the child UI component does not include another child UI component, based on the recognition model,
identify the child UI component and one or more properties of the child UI component; and
identify the one of the one or more UI components and one or more properties of the one of the one or more UI components.

31. The computing device of claim 28 wherein:
to recognize the one or more UI components includes to:
determine whether one of the one or more UI components includes a child UI component; and
in response to determining that the one of the one or more UI components does not include a child UI component, based on the recognition model, identify the one of the one or more UI components and the one or more properties of the one of the one or more UI components.
